(19) United States
(12) Patent Application Publication
(10) Pub. No.: US 2006/0005342 A1
(43) Pub. Date: Jan. 12, 2006

(54) Vehicle wheel cleaning attachment

(76) Inventor: Ray Comeau, Truro (CA)

Correspondence Address: G. Ronald Bell & Associates, P.O. Box 2450, Station D, Ottawa, K1P 7B6, CA

(21) Appl. No.: 11/176,314

(22) Filed: Jul. 8, 2005

Related U.S. Application Data
(60) Provisional application No. 60/585,855, filed on Jul. 8, 2004.

(51) Int. Cl. B08B 1/00

(52) U.S. Cl. 15/256.5

(57) ABSTRACT

A wheel cleaning apparatus adapted to be secured to an axle hub centered in a wheel of a vehicle. The apparatus comprises a mounting bracket having a bearing for securing the wheel cleaning apparatus to the axle hub, an arm extending radially from the mounting bracket and a cleaning element attached to the end of the arm adjacent to and in contact with the wheel. The bearing allows gravity to act upon the wheel cleaning apparatus ensuring the arm is oriented in a constant substantially downward direction so that contact with the entire surface of the wheel is achieved as the vehicle is in motion.

### BACKGROUND OF THE INVENTION

The present invention relates generally to the field of cleaning tools or apparatus and more specifically to an apparatus that may be temporarily attached to a vehicle wheel purposed to clean and polish the wheel.

Vehicle wheels in use today are available in a number of finishes, each requiring care to ensure the finish remains true to its original form. One such finish may be polished steel or aluminum. While in general use, a wheel affixed to a vehicle will be subjected to environmental factors and conditions contributing to the wheel becoming dirty, corroded, or tarnished. These factors may include, but are not limited to, mud, dirt, sand, road salt, precipitation, and petroleum products or wastes. Without periodic cleansing and polishing, the wheels will not display their original finish and will lack the desired aesthetic appearance.

Traditionally, vehicle wheels are cleaned and polished by hand, optionally utilizing cleansers and/or tools. In the most basic means, a soft cloth may be used and manual force applied to remove debris and polish the wheel. The use of tools and cleansers may ease the task but manual force is still required to achieve desired results.

Attachments for cleaning tires are known in the art. For example, within U.S. Pat. No. 5,188,394 Roche et al. describe a dump truck accessory for removing mud from between the truck's dual tires which is imperative prior to driving on a paved road. Hydraulic or pneumatic cylinders are used to move brushes between an operative and a retracted position. When in the operative position, the brushes contact the inner side walls of the tires as the truck moves. The brushes may be made of heavy wire coated with plastic.

In U.S. Pat. No. 6,434,781, Guerra teaches an attachment for a golf bag cart for cleaning the wheels thereof. The device is attached to the leg of a golf bag cart and contains brushes for contacting and cleaning the wheel's inner and outer walls as well as the periphery of the wheel, as the cart is rolled.

Each wheel cleaner is purposed to clean debris from the tire surface while failing to address the need to clean and polish the wheel itself.

### SUMMARY OF THE INVENTION

It is an object of the present invention to provide an apparatus that may be removably attached to a vehicle wheel and is designed to clean and polish the wheel while the vehicle is in motion.

According to an aspect of the present invention, there is provided a wheel cleaning apparatus comprising a mounting bracket for mounting the apparatus in the vicinity of the origin of a wheel, the mounting bracket comprising at least one bearing configured to facilitate rotation about the origin; an arm attached structured and dimensioned for radial attachment to the mounting bracket; and a cleaning element for connecting to an end of the arm distal to the mounting bracket, wherein the arm is adaptable for positioning of the cleaning element in substantial contact with at least a portion of the wheel.

The wheel cleaning apparatus is adapted to be secured to an axle hub centered in a wheel of a vehicle. The mounting bracket of the apparatus has a bearing for securing the wheel cleaning apparatus to the axle hub. The arm extending radially from the securing bracket is substantially in the plane of the wheel and the cleaning element is attached to the end of the arm adjacent to and in contact with the wheel. Typically, the arm is of sufficient weight such that the bearing allows gravity to act upon the wheel cleaning apparatus ensuring the arm is oriented in a constant substantially downward direction so that contact with the entire surface of the wheel is achieved as the vehicle is in motion. Optionally, a stabilizer arm may be provided that attaches to the body of the vehicle at one end and the arm of the wheel cleaning apparatus at the other end to secure the wheel cleaning apparatus in a downward position while the wheel is rotating.

Preferably, the cleaning element may be formed of an abrasive or smooth material capable of removing debris from the wheel or buffing and polishing the wheel. Suitable materials for the cleaning element include, but are not limited to, rubber, plastic, fabric, or brush materials.

According to another aspect of the present invention, there is provided a wheel cleaning apparatus comprising: a mounting bracket for mounting the apparatus in the vicinity of the origin of a wheel, the mounting bracket comprising at least one bearing configured to facilitate rotation about the origin; a plurality of arms structured and dimensioned for radial attachment to the mounting bracket; and a cleaning element for connecting to one or more ends of the arms distal to the mounting bracket, wherein the arms are adaptable for positioning of the cleaning elements in substantial contact with at least a portion of the wheel.

### BRIEF DESCRIPTION OF THE DRAWINGS

The above and other objects and the attendant advantages of the present invention will become readily apparent by reference to the following detailed description when considered in conjunction with the accompanying drawings, wherein:

FIG. 1 is a side view of a wheel cleaning apparatus according to an embodiment of the present invention;

FIG. 2 is a front view of the apparatus of FIG. 1;

FIG. 3 is a perspective view of the apparatus of FIGS. 1 and 2 affixed to a vehicle wheel;

FIG. 4 is a side view of a wheel cleaning apparatus according to another embodiment of the invention showing an optional stabilizer arm; and

FIG. 5 is a front view of a wheel cleaning apparatus according to another embodiment of the invention showing optional side abrasive material.

FIG. 6 is a perspective view of a wheel cleaning apparatus according to an embodiment of the present invention.

### DETAILED DESCRIPTION OF THE INVENTION

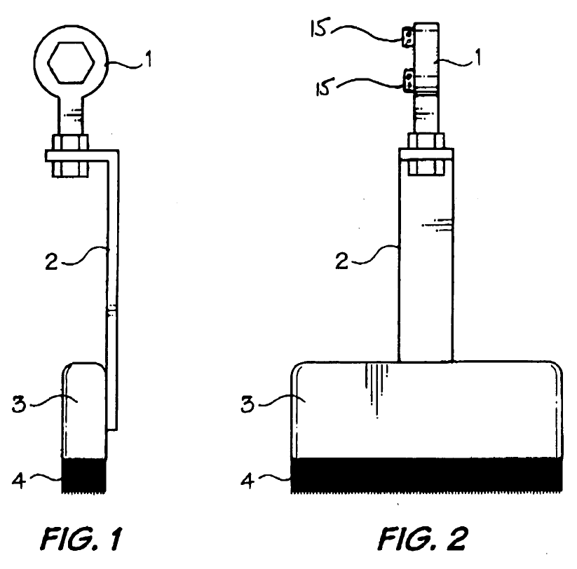

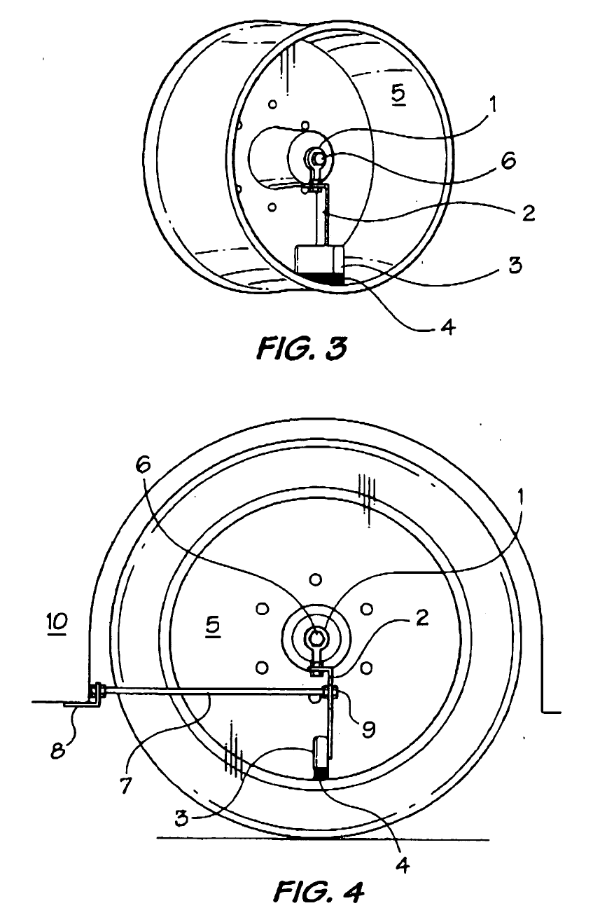

As shown in FIGS. 1 and 2, the wheel cleaning apparatus of the present invention comprises a mounting bracket 1 affixed to one end of an arm 2. The bracket 1 is typically tubular in shape to allow a bolt 6 to be passed through its center and comprises at least one bearing 15 allowing the bracket 1 to spin freely, independent of the arm 2 position. A cleaning element 4 is attached to the end of the arm 2 distal of the mounting bracket 1. Alternatively, the cleaning element 4 may be provided in conjunction with a head 3.

FIG. 3 shows the wheel cleaning apparatus of the present invention in an installed position within a wheel 5. The wheel cleaning apparatus is secured to the wheel 5 utilizing a bolt 6 passing though the mounting bracket 1 and into the axle hub of the wheel 5. The bearing 15 within the mounting bracket 1 spins freely while the wheel 5 rotates and the arm 2 remains in a near vertical position due to the effect of gravity. Alternatively, the wheel 5 could be held stationary and the wheel cleaning apparatus rotated relative to the wheel 5. The head 3 and/or the cleaning element 4 point substantially downward and are in frictional contact with the wheel 5. As the wheel 5 rotates, the cleaning element 4 will contact the entire inner surface of the wheel 5, ensuring a clean and/or polished surface is achieved.

The cleaning element 4 may be formed of a variety of materials, including natural or synthetic fibers, wire or wire coated in plastic or rubber.

According to another embodiment of the present invention the cleaning element 4 may comprise a head portion 3. The head 3 may be removably or permanently attached to the arm 2 and the head 3 adapted to allow for the exclusive replacement of the cleaning element 4 when worn or for the changing of the type of cleaning element 4 as warranted without replacing of the head 3.

According to a further embodiment of the present invention, as shown in FIG. 4, a stabilizer arm 7 is provided. The stabilizer arm 7 is connected at one end by a L-bracket 8 to the body or a portion of the vehicle 10 and at the other end to the arm 2 of the wheel cleaning apparatus through a connection means 9. The stabilizer arm 7 holds the arm 2 of the wheel cleaning apparatus in a downward position and prevents the wheel cleaning apparatus from rotating while the wheel 5 is in motion.

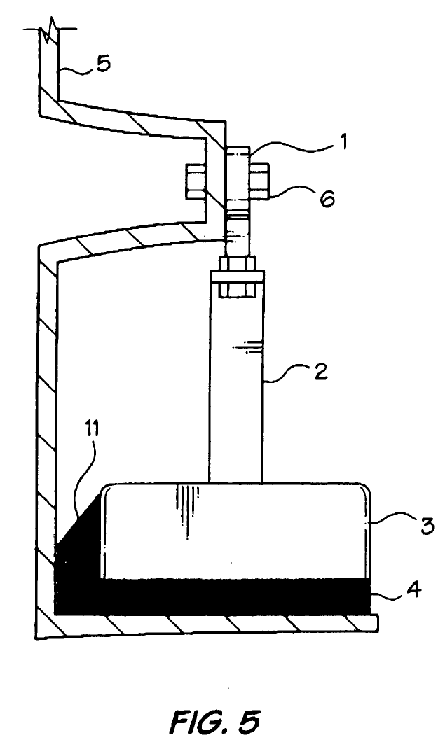

According to a further embodiment of the present invention, as shown in FIG. 5, a secondary cleaning element 11 is provided. The secondary cleaning element 11 is attached to one side of the head 3 to allow for cleaning and polishing of the inner vertical surface of the wheel 5. The secondary cleaning element 11 can be formed of the same or different material as provided for the cleaning element 4.

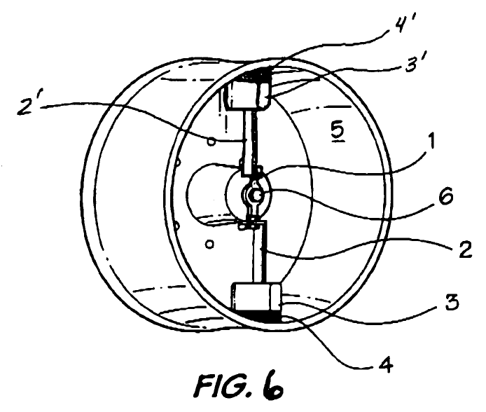

FIG. 6 illustrates a further embodiment of the present invention, wherein more than one arm 2′ is attached to the mounting bracket 1. Each additional arm 2′ can be attached to a cleaning element 4′ and optionally a head 3′. Although only one additional arm 2′ is illustrated in FIG. 6, it will be understood by those skilled in the art that a plurality of arms may be provided. Each arm can be attached to the same or different cleaning elements, or may be provided only for stabilization of the apparatus. As shown in FIG. 6, the additional arm 2′ may be provided offset to the arm 2. Alternatively, the arms 2, 2′ may be provided as a unitary structure defining a longitudinal axis (not shown). All other features and embodiments described for the embodiment of the wheel cleaning apparatus having only one arm are applicable to the embodiment of the wheel cleaning apparatus having more than one arm.

It should be understood that the specific form of the invention hereinabove described is intended to be representative only, as certain modifications within the scope of these teachings will be apparent to those skilled in the art.

I claim:

1. A wheel cleaning apparatus comprising:
a mounting bracket for mounting said apparatus in the vicinity of the origin of a wheel, said mounting bracket comprising at least one bearing configured to facilitate rotation about the origin;
an arm structured and dimensioned for radial attachment to said mounting bracket; and
a cleaning element for connecting to an end of said arm distal to said mounting bracket,
wherein said arm is adaptable for positioning of said cleaning element in substantial contact with at least a portion of said wheel.

2. The wheel cleaning apparatus according to claim 1, wherein said wheel cleaning apparatus is adapted to be maintained in a stationary position during cleaning and said wheel is rotated relative to said wheel cleaning apparatus.

3. The wheel cleaning apparatus according to claim 1, wherein said wheel is maintained in a stationary position during cleaning and said wheel cleaning apparatus is rotated relative to said wheel.

4. The wheel cleaning apparatus according to claim 1, wherein said cleaning element comprises a head portion for releasable attachment to said arm.

5. The wheel cleaning apparatus according to claim 1, wherein said cleaning element comprises an abrasive material effective for removing debris from said wheel.

6. The wheel cleaning apparatus according to claim 1, wherein said cleaning element comprises a smooth material effective for buffing and/or polishing said wheel.

7. The wheel cleaning apparatus according to claim 1, wherein said cleaning element comprises natural or synthetic fibers, wire or wire coated in plastic or rubber.

8. The wheel cleaning apparatus according to claim 2, wherein said arm is of sufficient weight in order to maintain said arm during operation in a position corresponding to the direction of the force of gravity.

9. The wheel cleaning apparatus according to claim 2, further comprising a stabilizer arm linking said wheel cleaning apparatus to a portion of a vehicle having said wheel attached thereto, whereby said stabilizer arm maintains said wheel cleaning apparatus in a stable position when said wheel is rotated.

10. The wheel cleaning apparatus according to claim 1, wherein said mounting bracket is adapted for attachment to said origin of said wheel by a bolt inserted through a passage in said mounting bracket into an axle hub of said wheel.

11. The wheel cleaning apparatus according to claim 4, further comprising a secondary cleaning element adapted for attachment to one side of said head to allow for cleaning and polishing of an inner vertical surface of said wheel.

12. A wheel cleaning apparatus comprising:
a mounting bracket for mounting said apparatus in the vicinity of the origin of a wheel, said mounting bracket comprising at least one bearing configured to facilitate rotation about the origin;
a plurality of arms structured and dimensioned for radial attachment to said mounting bracket; and
a cleaning element for connecting to one or more ends of said arms distal to said mounting bracket,
wherein said arms are adaptable for positioning of said cleaning elements in substantial contact with at least a portion of said wheel.

13. The wheel cleaning apparatus according to claim 12, wherein said wheel cleaning apparatus is adapted to be maintained in a stationary position during cleaning and said wheel is rotated relative to said wheel cleaning apparatus.

14. The wheel cleaning apparatus according to claim 12, wherein said wheel is maintained in a stationary position during cleaning and said wheel cleaning apparatus is rotated relative to said wheel.

15. The wheel cleaning apparatus according to claim 12, further comprising one or more heads adapted for attachment to the end of said arms distal of said mounting bracket, wherein said cleaning element is connected to one or more of said heads.

16. The wheel cleaning apparatus according to claim 12, wherein said cleaning element comprises an abrasive material capable of removing debris from said wheel or a smooth material capable of buffing and/or polishing said wheel.

17. The wheel cleaning apparatus according to claim 12, wherein said cleaning element comprises natural or synthetic fibers, wire or wire coated in plastic or rubber.

18. The wheel cleaning apparatus according to claim 13, wherein at least one of said arms is of sufficient weight in order to maintain said arm during operation in a position corresponding to the direction of the force of gravity.

19. The wheel cleaning apparatus according to claim 13, further comprising a stabilizer arm linking said wheel cleaning apparatus to a portion of a vehicle having said wheel attached thereto, whereby said stabilizer arm maintains said wheel cleaning apparatus in a stable position when said wheel is rotated.

20. The wheel cleaning apparatus according to claim 12, wherein said mounting bracket is attached to said origin of said wheel by a bolt inserted through a passage in said mounting bracket into an axle hub of said wheel.
